(19) United States
(12) Patent Application Publication
(10) Pub. No.: US 2007/0064649 A1
(43) Pub. Date: Mar. 22, 2007

(54) Two-layer network identification

(76) Inventors: Tero Makela, Helsinki (FI); Mika Liljeberg, Helsinki (FI); Fabien Rapin, Vantaa (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/229,046

(22) Filed: Sep. 16, 2005

(51) Int. Cl. H04Q 7/00

(52) U.S. Cl. 370/331

(57) ABSTRACT

A method, apparatus, system, and software product are presented for managing data flow via connections between a mobile terminal and a destination internet protocol network. A plurality of sets of connection parameters are accessed by a mobile terminal, each of the sets including at least one parameter for an access point, at least one parameter for an access network, and at least one parameter for a destination network. The connection for part of the data flow is then automatically selected and utilized based upon the triplet sets of connection parameters.

### FIELD OF THE INVENTION

This invention pertains to management by a mobile terminal of internet protocol (IP) communication in a multi-bearer environment.

### BACKGROUND OF THE INVENTION

In a multi-bearer environment, a mobile terminal can access IP services via several access IP networks that may have overlapping IP address ranges. On the other hand, coping with a set of several access networks is difficult unless there is enough information to enable the mobile terminal to manage the data connections.

The user or client application is typically most interested in the services that are available from the destination IP network. A common example of the destination IP network is the Internet, which can be accessed via several access networks. Ideally, the data connections to the Internet or other destination network should be moveable from one access network to another with little or no interference to the user of mobile terminal.

The basic problem is to describe the network topology to the mobile terminal in such a way that the mobile terminal can automatically select the best possible access to each individual data connection. That problem comprises the following four items: (1) making the connection selection as simple as possible for the user of the mobile terminal; (2) selecting the best available access network automatically; (3) providing information as to which access networks are interchangeable in terms of IP routing and in terms of application level services; and (4) structuring configuration information in such a way that it can be easily managed with an Over the Air (OTA) configuration and manual configuration done by the user. Items 1-3 are not fulfilled by currently available technology. Item 4 is worth mentioning, because configuration settings will inevitably become more complicated, and it is essential to get the configuration right so that automatic connection selection and seamless roaming can occur.

The SYMBIAN operating system (OS) has had an identifier called “Network ID” since version 7.0S of the SYMBIAN OS. The purpose of that identifier is to make several simultaneous IP data connections possible, for example with overlapping IP addresses. This SYMBIAN Network ID assists with IP routing problems in a multi-homing environment, but so far it has not been adapted for phone products.

When someone connects his or her network to two different Internet service providers (ISPs), that exemplifies multi-homing, which provides redundancy and network optimization by selecting the ISP offering the best path to a resource. In other words, multi-homing involves the ability to use multiple concurrent IP addresses. Where a user may be streaming audio and browsing, while performing a back-office synchronization and receiving an MMS message, he or she is likely to be using multiple IP addresses. Multi-homing is not limited to the telephony side; it also allows different IP addresses for other services such as Bluetooth wireless technology, PC connectivity, or ethernet. The term multi-homing is used in this application broadly, to include any multi-bearer situation.

In addition to not being adapted to phones, the SYMBIAN Network ID offers only a partial solution to the whole problem of connection management and seamless mobility. The “IPv6 Scoped Address Architecture” (http://www1.ietf.org/proceedings_new/04nov/IDs/draft-ietf-ipv6-scoping-arch-02.txt downloaded on Sep. 1, 2005) can also be seen as background for the present invention, in the limited sense that it is used to distinguish between interfaces that are connected to overlapping IP address spaces. Unfortunately, however, there has so far not been a complete solution for connection management in a multi-homing environment.

### SUMMARY OF THE INVENTION

Network topology is described in a phone in such a way that automated selections can be made in the data connection setup phase and during the connection. This solves the problem of how to automate connection selection and roaming. Roaming of data flows is enabled between interfaces connected to IP spaces that possibly overlap, and this is achieved by presenting connection parameters in a triplet configuration. Each triplet includes parameters for an access point, and access network, and a destination.

The present invention extends the idea of a network ID further, and consequently provides a more complete solution for the problem of connection management and seamless mobility. The present invention provides a mechanism to enable the roaming of data flows between interfaces connected to possibly overlapping IP spaces, which has not been done before.

To this end, a triplet configuration is used to represent connection parameters. The first part of the triplet is an access point (also known as an “internet access point” or IAP) providing parameters that are specific to an access mechanism and subscriber, such as dial-up number (CSD), Access Point Name APN (GPRS/WCDMA), username, password, and the like. The second part of the triplet is an Access Network ID which identifies the access IP network independent of the radio bearer. The Access Network ID can contain one or several interchangeable access points. Local services such as the Simple Mail Transfer Protocol (SMTP) server, the HTTP proxy, or the Mobile IP home agent must be reachable from any node within the access network. The third part of the triplet is a Destination Network ID that identifies the destination IP network whose service the mobile terminal/user is using. The Destination Network ID can contain one or several interchangeable access networks. The name resolution in the destination network must return the same answer from all the access networks within that destination network.

It is possible to move data flow from one connection to another and access the services of the original connection, within the destination network, but this usually requires an application to adapt or initiate such a connection change. This is called semi-seamless roaming, or application assisted roaming. Within an access network, it is possible to move data flows seamlessly from one connection to another with the help of mobile IP. Note that in some cases it is possible to use seamless roaming between access networks, although that use is not covered by the present invention.

The connection parameter triplet described above is used in both a data connection setup and when making roaming decisions for active connections. In the connection setup, this invention makes it possible for an application or user to activate a data connection to a certain destination network, such as the Internet or office intranet, and let middleware (i.e. software that connects two otherwise separate applications) take care of selecting the optimal available radio bearer automatically. Based on access and destination network information, the middleware can make decisions as to whether there is a better connection available for some of the existing data flows, and whether seamless roaming or application-assisted roaming should be used when moving the data flow from one connection to another. Thus, by describing the network topology in the phone in such a way that automated selections can be made in the data connection setup phase and during the connection, the problem is solved as to how connection selection and roaming can be automated.

### BRIEF DESCRIPTION OF THE DRAWINGS

FIG. 1 presents an example network topology.

FIG. 2 presents an example of connection configuration data structures.

FIG. 3 presents an example of component architecture.

FIG. 4 is a flow diagram showing a method according to an embodiment of the present invention.

FIG. 5 is a block diagram showing a mobile terminal according to an embodiment of the present invention.

### DETAILED DESCRIPTION OF THE INVENTION

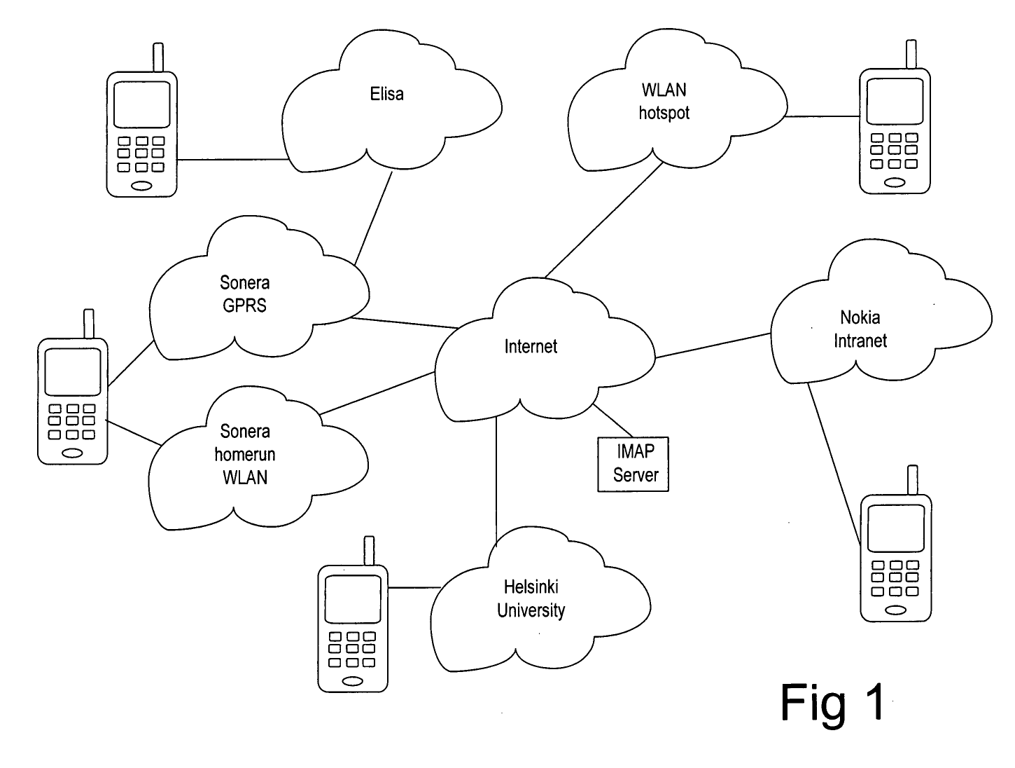

The triplet configuration of the present invention can be seen as a hierarchical system where one destination network is reachable via several access networks, which in turn can be accessed via several access points (IAPs). An example configuration can be seen in the following table which maps to the network topology of FIG. 1. The fourth column (underlying destination network ID) is needed when one connection is tunneled inside the other, e.g., in the case of a Virtual Private Network (VPN). In the example described in the following table, Elisa and Sonera are mobile network operators.

| | | | Underlying |
|---|---|---|---|
| Destination | Access | Internet Access | Destination |
| Network ID | Network ID | Point (IAP) | Network ID |
| Internet | Sonera Internet | Sonera Internet | |
| | | General Packet | |
| | | Radio Service | |
| | | (GPRS) | |
| Internet | Sonera Internet | Sonera Homerun | |
| | | Wireless Local | |
| | | Area Network | |
| | | (WLAN) | |
| Sonera | Sonera MMS | Sonera MMS GPRS | |
| Multimedia | | | |
| Messaging | | | |
| Service (MMS) | | | |
| Sonera Wireless | Sonera WAP | Sonera WAP GPRS | |
| Application | | | |
| Protocol (WAP) | | | |
| Sonera IP | Sonera IMS | Sonera IMS GPRS | |
| Multimedia | | | |
| Subsystem (IMS) | | | |
| Internet | Helsinki | Helsinki | |
| | University | University IP | |
| | | Passthrough | |
| Internet | Helsinki | Helsinki | |
| | University | University | |
| | | Dial-up Service | |
| Nokia Intranet | Nokia Intranet | Nokia WLAN | |
| | | with Wi-Fi | |
| | | Protected | |
| | | Access (WPA) | |
| Nokia Intranet | Nokia Intranet | Nokia IP | |
| | | Passthrough | |
| Nokia Intranet | Nokia Intranet | Nokia Dial-up | |
| | | Service | |
| Nokia Intranet | Nokia Intranet | Nokia Bluetooth | |
| | | PAN | |
| Internet | Public WLAN | Easy WLAN | |
| | | Connection | |
| Internet | Elisa Internet | Home WLAN | |
| Internet | Elisa Internet | Home IP | |
| | | Passthrough | |
| Nokia Intranet | Nokia Intranet | Virtual Private | Internet |
| | | Network (VPN) | |
| | | Nokia Intranet | |
| | | Over Internet | |
| Nokia Intranet | Nokia Intranet | VPN Nokia | WANO |
| | | Intranet | |
| | | Over WANO | |
| Nokia WANO | Nokia WANO | Nokia WANO | |
| (untrusted | | | |
| WLAN) | | | |

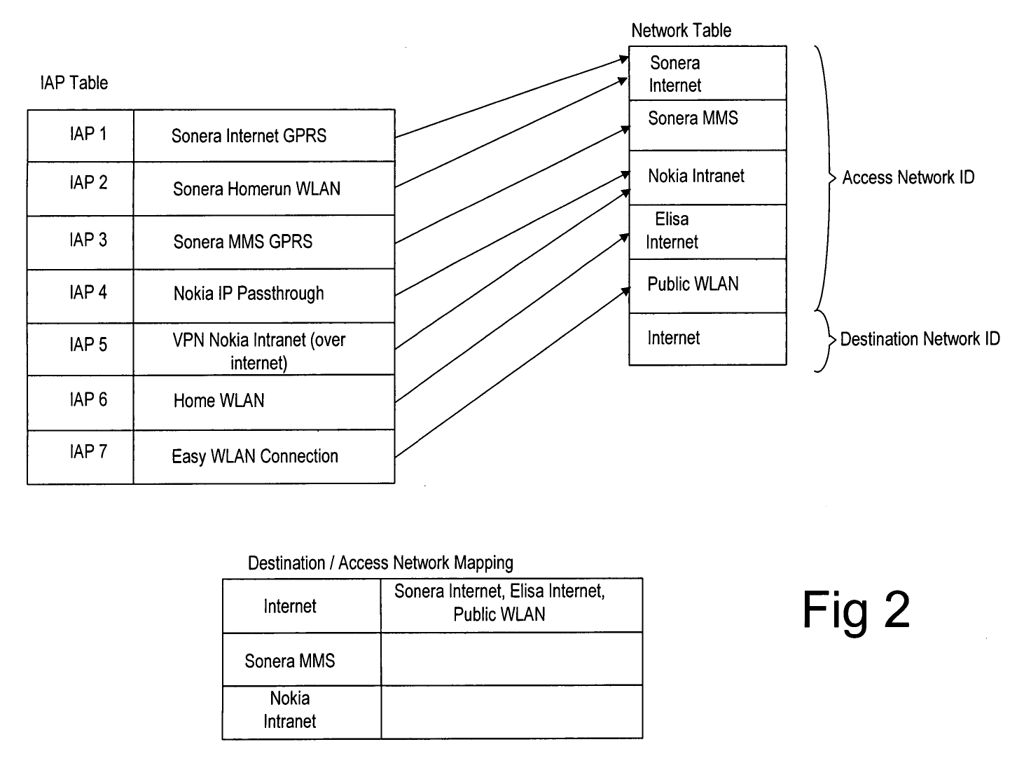

The set of configuration information shown in FIG. 2 exemplifies how the connection management settings could be stored. The idea is to store both access network IDs and destination network IDs in the same table, and use a completely new table for mapping information between access and destination networks. That way, both the IAP table and network table will require no changes (binary compatibility preserved).

The network table must contain an entry for each access network. Quite often, the access network is the same as the destination network (e.g. intranet). In those cases, only one entry is enough. If there are destination networks that are not access networks (e.g. the Internet), then they must also have an entry in the network table. The IAPs are associated with access network IDs.

The network table itself does not contain any mapping information between destination and access network entries; that would change the structure of the table and break binary compatibility (BC). Therefore, the complete list of destination networks can be found from the separate mapping table of the present invention, and that is the one that should be used (see left column in FIG. 2) for presenting the dialog to the user in a connection setup. When the destination network selection has been made by the user or application, all the access networks are checked based on the mapping table, and also each destination network is implicitly included in the selection. Then the highest ranking IAP is chosen from any of the access networks.

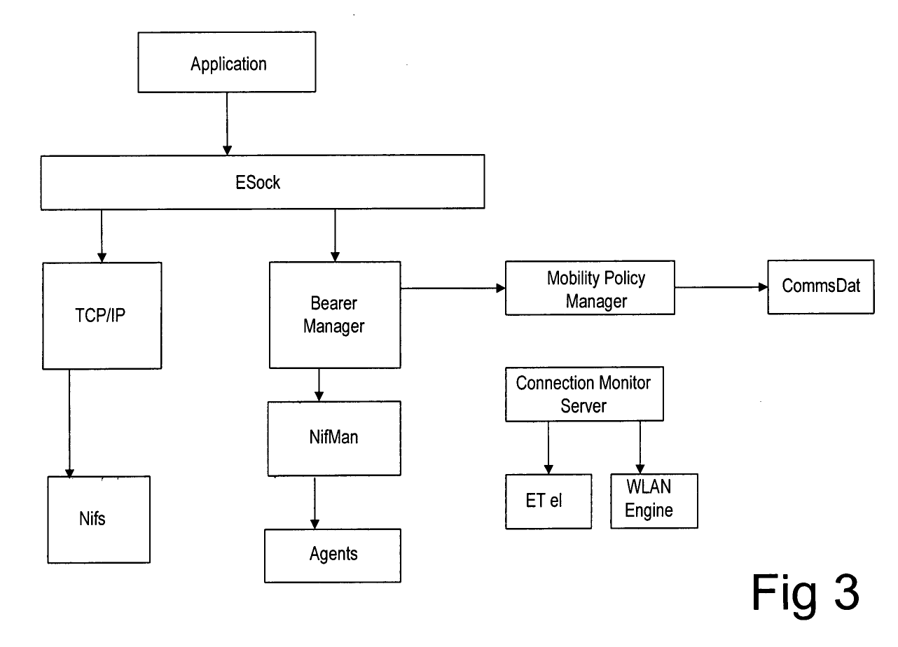

The new components that take into account access and destination networks, and handle the automated connection selection and roaming decisions, are here called Bearer Manager and Mobility Policy Manager. Their position in the system architecture is described in FIG. 3.

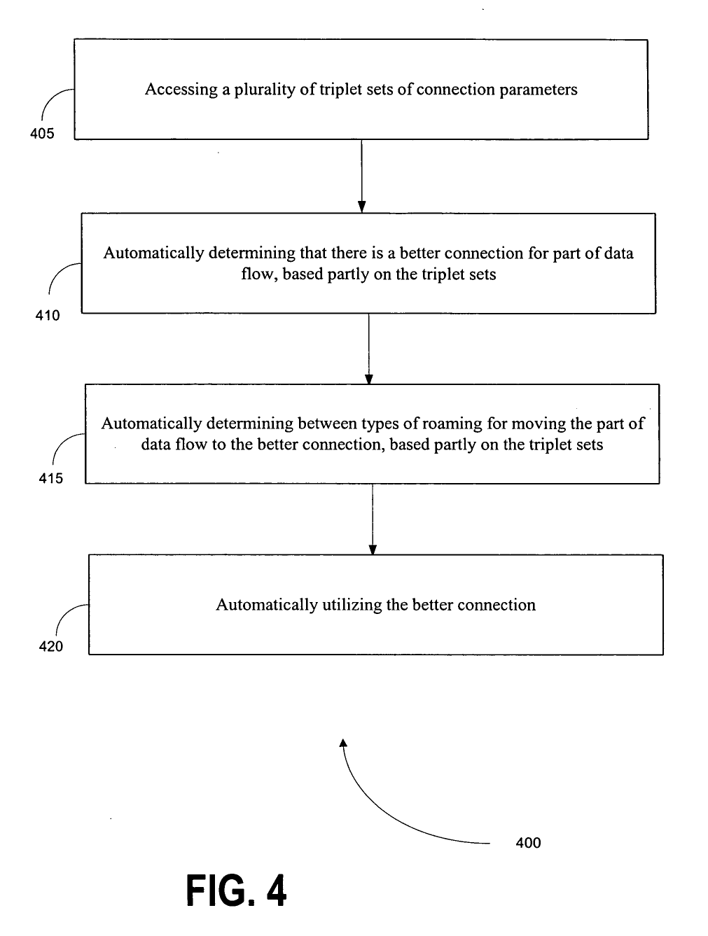

FIG. 4 illustrates a method according to an embodiment of the invention. The method 400 begins by accessing 405 a plurality of triplet sets of connection parameters, each of the triplet sets having parameters for an access point, and access network, and a destination network. Then, it is automatically determined 410 that there is a better connection for part of the data flow, based partly on the information provided by the triplet sets. Subsequently, a determination is automatically made 415 as to the type of roaming (seamless versus application-assisted) that will be used to move the portion of the data flow to the better connection, again based partly on the information provided by the triplet sets. Finally, the better connection is utilized 420.

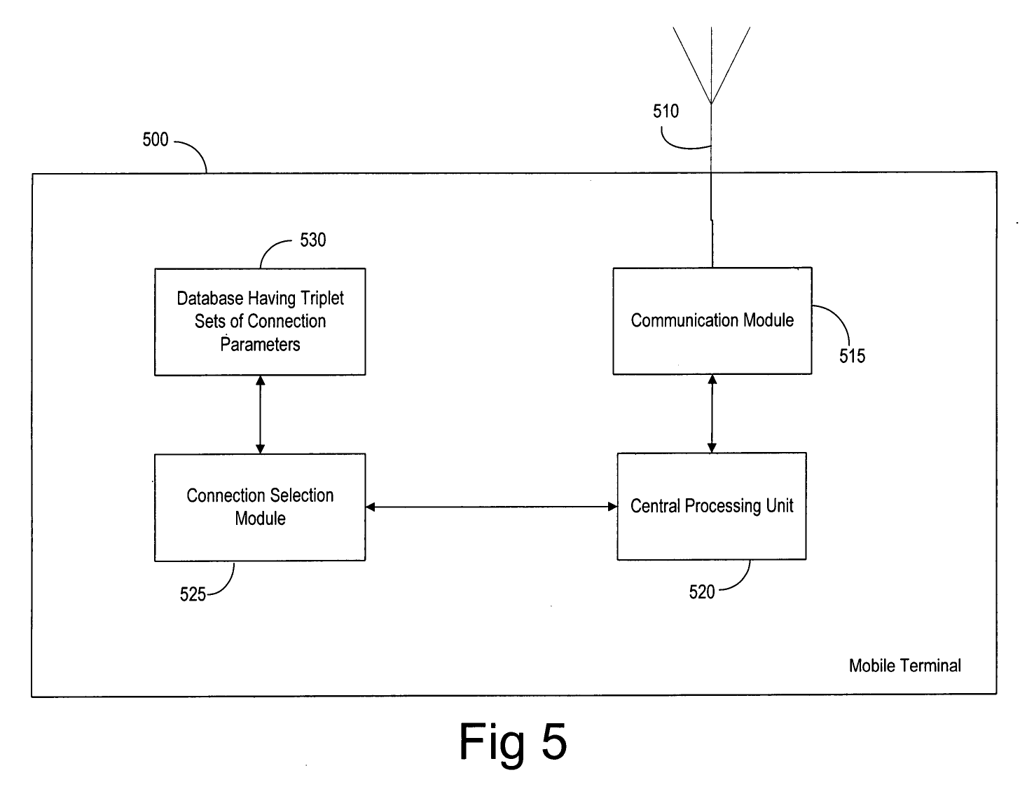

Turning now to FIG. 5, this illustrates a mobile terminal 500 according to an embodiment of the present invention. A database 530 contains the triplet sets of connection parameters. A connection selection module 525 uses data from the database to select a better connection for part of the data flow that passes through the communication module 515 and the antenna 510. The central processing unit 520 implements the selection made by the selection module 525.

It is to be understood that all of the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method for managing at least one data flow via at least one connection between a mobile terminal and a destination internet protocol network, comprising the steps of:
accessing a plurality of sets of connection parameters, each of the sets including at least one parameter for an access point, at least one parameter for an access network, and at least one parameter for a destination network; and
automatically selecting and utilizing the at least one connection for the at least one data flow based at least partly upon the sets of connection parameters.

2. The method of claim 1, wherein the step of automatically selecting the at least one connection includes making a determination whether there is a better connection than an existing connection for part of the at least one data flow, and if so then making a further determination whether seamless roaming or application-assisted roaming will be used to move the part of the at least one data flow to the better connection.

3. The method of claim 1, wherein the step of automatically selecting the at least one connection is performed during data connection setup.

4. The method of claim 1, wherein the plurality of sets of connection parameters include at least one destination network accessible by at least two access networks, and wherein at least one of the at least two access networks is accessible by at least two access points.

5. A mobile terminal for managing at least one data flow via at least one connection between the mobile terminal and a destination internet protocol network, comprising:
a database having a plurality of sets of connection parameters, each of the sets including at least one parameter for an access point, at least one parameter for an access network, and at least one parameter for a destination network; and
a connection selection module for automatically selecting the at least one connection for the at least one data flow at least partly in response to the sets of connection parameters.

6. The mobile terminal of claim 5, wherein the connection selection module is also for making a determination whether there is a better connection than an existing connection for part of the at least one data flow, and if so then making a further determination whether seamless roaming or application-assisted roaming will be used to move the part of the at least one data flow to the better connection.

7. The mobile terminal of claim 5, wherein the connection selection module is for automatically selecting the at least one connection during data connection setup.

8. The mobile terminal of claim 5, wherein the plurality of sets of connection parameters include at least one destination network accessible by at least two access networks, and wherein at least one of the at least two access networks is accessible by at least two access points.

9. A system for managing at least one data flow via at least one connection between a mobile terminal and a destination internet protocol network, comprising:
a database having a plurality of sets of connection parameters, each of the sets including at least one parameter for an access point, at least one parameter for an access network, and at least one parameter for a destination network; and
a connection selection module in the mobile terminal for automatically selecting the at least one connection for the at least one data flow at least partly in response to the sets of connection parameters.

10. A software product for managing at least one data flow via at least one connection between a mobile terminal and a destination internet protocol network, the software product comprising a computer readable medium having executable codes embedded therein; the codes, when executed, adapted to carry out the steps of:
accessing a plurality of sets of connection parameters, each of the sets including at least one parameter for an access point, at least one parameter for an access network, and at least one parameter for a destination network; and
automatically selecting and utilizing the at least one connection for the at least one data flow based at least partly upon the sets of connection parameters.
